(19) United States
(12) Patent Application Publication
(10) Pub. No.: US 2006/0107900 A1
(43) Pub. Date: May 25, 2006

(54) QUICK-RELEASE TOP CAP FOR BIRD FEEDERS

(75) Inventor: Robert E. Bescherer, Bristol, RI (US)

Correspondence Address: BARLOW, JOSEPHS & HOLMES, LTD., 101 DYER STREET, 5TH FLOOR, PROVIDENCE, RI, 02903, US

(73) Assignee: ASPECTS, INC., Warren, RI (US)

(21) Appl. No.: 11/162,767

(22) Filed: Sep. 22, 2005

Related U.S. Application Data
(60) Provisional application No. 60/629,993, filed on Nov. 22, 2004.

(51) Int. Cl. A01K 61/02

(52) U.S. Cl. 119/57.8

(57) ABSTRACT

A bird feeder with a tubular body member having a sidewall and an open top end includes a top cap member that engages the top end of the tubular body and also has a means for releasably securing the top cap to the tubular body. The top cap is releasably secured to the tubular body by the engagement of a lock slot that communicates with a lock protrusion on the sidewall. A spring member biases the top cap away from the tubular body to keep the lock protrusions seated in the lock slots. Preferably, there are two lock slots on opposing sides of the top cap with corresponding lock protrusions on the tubular body. The top cap is depressed to overcome the resilient spring member to unseat the lock protrusions to permit releasable attachment of the tubular body of the feeder thereon enabling easy access to the interior of the feeder.

### CROSS-REFERENCE TO RELATED APPLICATION

This application claims priority to earlier filed U.S. Provisional Application Ser. No. 60/629,993, filed Nov. 22, 2004, the contents of which are incorporated herein by reference.

### BACKGROUND OF THE INVENTION

1. Field of the Invention

The present invention generally relates to bird feeders, namely, tubular bird feeders. More specifically, the present invention relates top caps for such feeders.

2. Background of the Related Art

In the bird feeder industry, tubular bird feeders are very well known. These feeders include a tubular main feed body with feed ports in the tubular body permit birds to gain access to the feed therein. A tubular bird feeder also typically includes a number of perches routed through or attached to the tubular body to support a bird during feeding through one of the feed ports. The bottom of the main tubular body includes a bottom base or cap. This base is usually screwed on or riveted to the bottom of the tubular main body to keep it closed.

The top open end of the feeder is usually covered by a removable cap so feed may be introduced into the tubular body. Bails are also provided so the feeder can be hung from a support. These top caps of prior art known tubular bird feeders are usually loosely fitting members that simply sit on the top of the open tube to protect the feed therein by preventing water and other debris from entering the tubular body. Also, a top cap assists in preventing squirrels from directly feeding on the feed residing within the tubular body. The bail wire is commonly routed through the cap to engage with a rod permanently positioned through the tubular member. The top cap can be removed by sliding it along the length of the bail wire. However, when the top cap is removed, the permanently positioned rod makes it difficult to gain access to interior of the tubular member for cleaning. Also, the loose fitting top cap often can be easily removed by squirrels.

Therefore, there is a need to be able to provide clear access to the interior of the tubular body for cleaning and for loading of the feeder with feed. There is a need to be able to provide such access in addition to providing a bail wire to enable the feeder to be hung in the usual fashion. There is also a desire to more securely attach a top cap to a feeder to prevent squirrels and other vermin from entering the feeder and stealing the feed contained therein.

### SUMMARY OF THE INVENTION

The present invention provides a solution to the problems associated with prior art tubular bird feeders. As shown in the attached figures, the bird feeder of the present invention includes a new and novel quick-release top cap that is easily removable from the top of the main tubular body of the feeder. In general, the present invention provides a new quick-release top cap that has a unique new construction that enables the cap to be removed fast yet enables the full access to the interior of the tubular body of the feeder. The bird feeder of the present invention includes a tubular body member having an open top end and a side wall. A top cap member interfits with the top end of the tubular body member and is releasably secured thereon by at least one lock protrusion connected to the tubular body member and at least one lock slot on the to cap member. The lock slot engages the lock protrusion to secure the top cap to the tubular body member.

Accordingly, an object of the present invention is the provision for a top cap for a bird feeder that is quickly and easily removed.

Another object of the present invention is the provision for a top cap for a bird feeder that is tamper resistant to squirrels, chipmunks and other vermin.

Yet, another object of the present invention is the provision for a removable top cap for a bird feeder that resists accidental release from the bird feeder.

Yet, another object of the present invention is the provision for a removable top cap for a bird feeder that facilitates cleaning of the bird feeder.

Yet, another object of the present invention is the provision for a removable top cap for a bird feeder that has a bail to suspend the bird feeder therefrom.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the preferred embodiment of the present invention installed on a tubular bird feeder;

FIG. 2 is a bottom perspective view of the preferred embodiment of the present invnetion;

FIG. 3A is a top perspective view of the top portion of a tubular bird feeder;

FIG. 3B is a top perspective view showing installation of the locking rod;

FIG. 4A is a side elevational view of the preferred embodiment resting on the tubular bird feeder;

FIG. 4B is a cross-sectional view through line 4B-4B of FIG. 4A;

FIG. 5A is a side elevational view of the preferred embodiment being forced downwardly onto the tubular bird feeder;

FIG. 5B is a cross-sectional view through line 5B-5B of FIG. 5A;

FIG. 6 is a side elevational view of the preferred embodiment of the present invention in a rotated position;

FIG. 7 is a side elevational view of the preferred embodiment of the present invention rotated and released;

FIG. 8 is a bottom exploded view of the preferred embodiment of the present invention;

FIG. 9 is a cross-sectional view of the present invention with a squirrel guard installed thereon; and

FIG. 10 is a top perspective view of the preferred embodiment of the present invention installed on a tubular bird feeder with a squirrel guard and squirrel cage attached thereto.

### DESCRIPTION OF THE PREFERRED EMBODIMENT

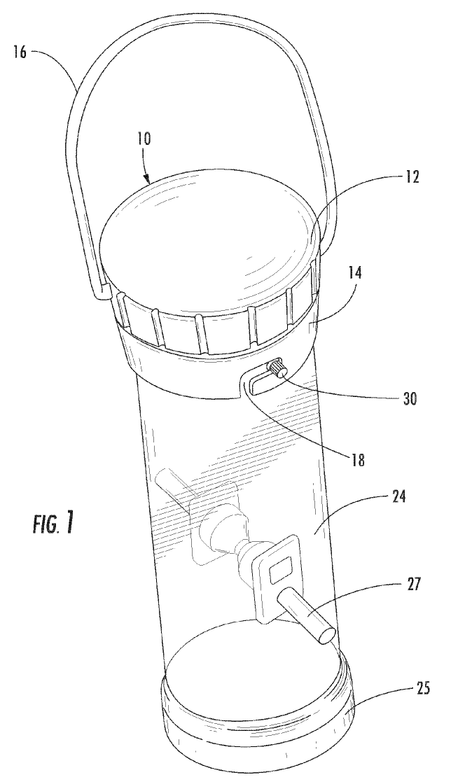

In FIG. 1, the top cap 10 includes an upper portion 12 and a lower portion 14. The upper portion 12 preferably has a roughened or knurled outer surface to facilitate rotation thereof. Other surface enhancements, such as circumferential cut-outs, can be used to assist in the rotation of the cap 10. A bail 16 is attached to the upper portion 12 of the cap 10. The lower portion 14 includes a pair of locking slots 18, as will be described in detail below. One of them is seen in FIG. 1. The top cap 10 is releasably mountable to a tubular body 24 with base 25 and perches 27. The tubular body 24, base 25, and perches 27 are well known in the art, and, therefore, need not be discussed in further detail herein.

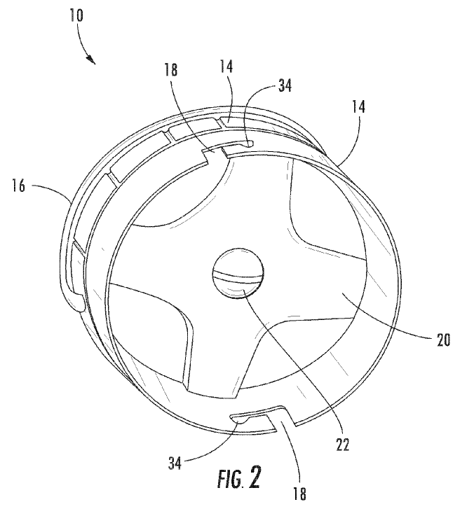

In FIG. 2, the lower portion 14 of cap 10 includes the locking slots 18 and a spring-biasing member 20 that is attached to the lower side of the lower portion 14 of the cap 10 with a screw 22. The spring-biasing member 20 flexes outwardly away from the lower portion 14 of the top cap 10. The functionality of the spring member 20 will be discussed in greater detail below.

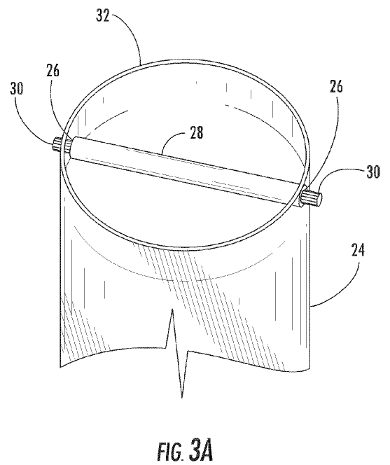

In FIGS. 3A and 3B, the top open end of the tubular body 24 includes two opposed apertures 26 to receive the rod 28 therethrough. The tubular body 24 is preferably flexible so it can be easily squeezed, as shown in FIG. 3B, to permit the free ends 30, serving as lock protrusions, of the rod 28 to be routed into the respective opposing apertures 26. When the tubular body 24 is released, as shown in FIG. 3A, the lock protrusions 30 extend outwardly from the tubular body 24. Although a rod 28 fitted into to apertures 26 on the tubular body 24 to form the lock protrusions 30 is the preferred construction of the preferred embodiment of the present invention, other structures may be easily implemented that are well known in the art. For instance, the lock protrusions 30 could be integral extensions of the tubular body 24.

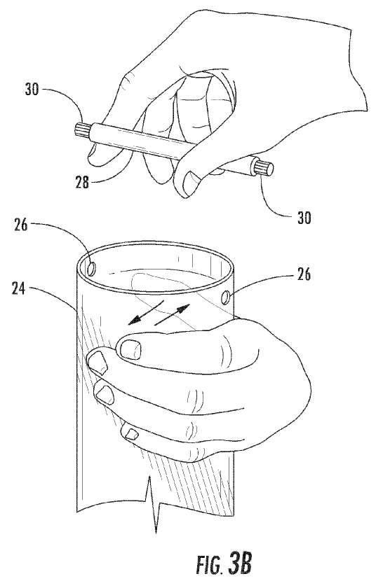

As seen in FIG. 4A, the top cap 10 is placed over the open end of the tubular body 24 so that the lock protrusions 30 reside within the vertical portion of the locking slots 18. The spring-biasing member 20 bears on the top edge 32 of the tube 24 to spring-bias it upwards, which can be best seen in FIG. 4B.

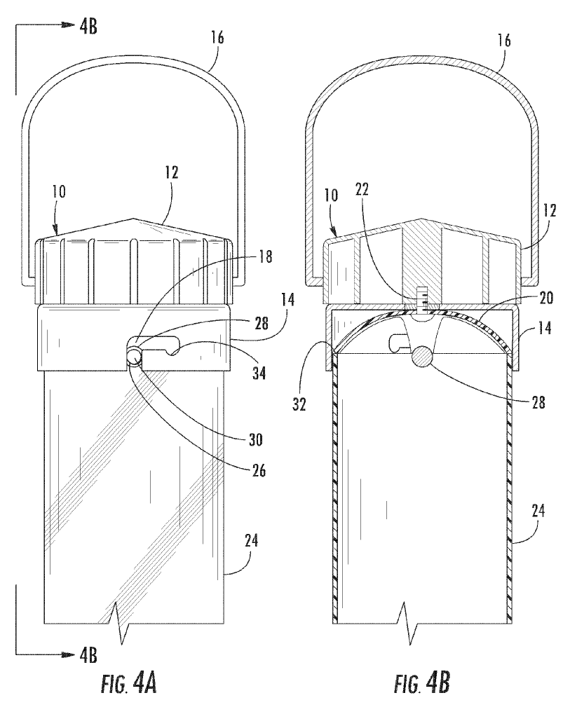

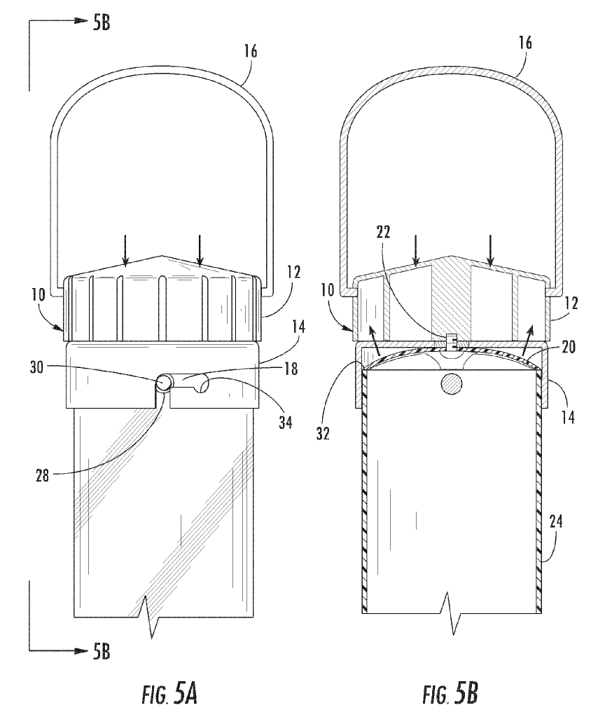

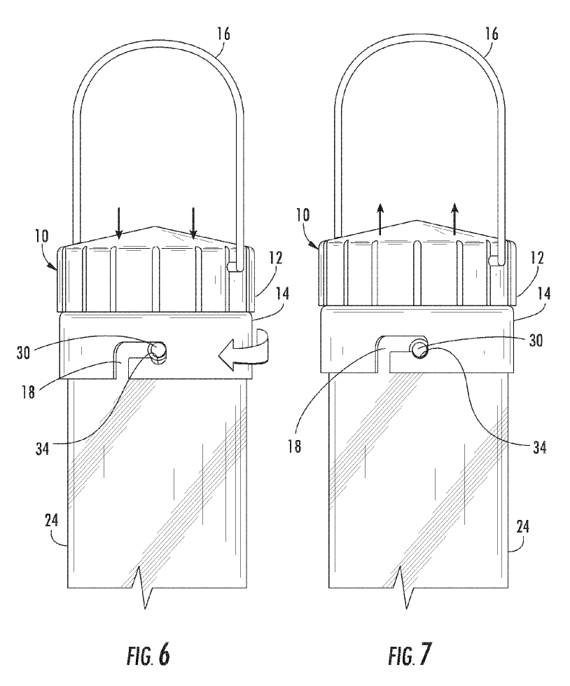

In FIGS. 5A, 5B and 6, the top cap 10 is pressed down against the forces of the spring-biasing member 20 so that the lock protrusions 28 can ride laterally along the length of their respective locking slots 18. The deflection of the spring-biasing member 20 when pressed down can best be seen in FIG. 5B. When the lock protrusions 30 each reach their respective lock seat 34 at the end of the locking slots 18, as shown in FIG. 6, the cap 10 is released where the spring-biasing member 20 retains the protrusions 30 in their respective lock seats 34. FIG. 7 shows the lock protrusions 30 securely seated in the lock seats 34 of the lock slots 18. The forces of the spring-biasing member 20 are sufficient to prevent the lock protrusions 30 from being unseated from their respective lock seats 18 under forces from weather and squirrels and other animals while being easily manipulatable by a person for desired removal for filling the feeder of for cleaning, and the like, as will be described below.

The top cap 10 is removed by pressing down on the top cap 10 so that the lock protrusions 30 can clear out of their seat 34 to permit rotation and subsequent removal of the cap 10. For easy cleaning, the rod 28 can then be removed by squeezing the tubular body 24 of the feeder so that the protrusions 30 can be removed from their apertures 26 so full access of the interior of the tubular body 24 can be achieved. For filling the tubular body 24 with feed, the rod 28 need not be removed.

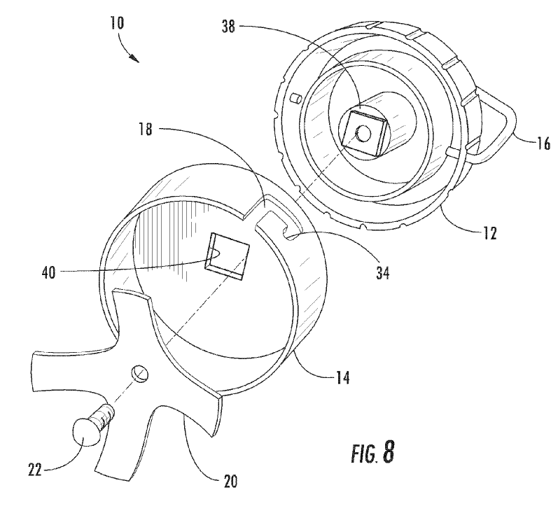

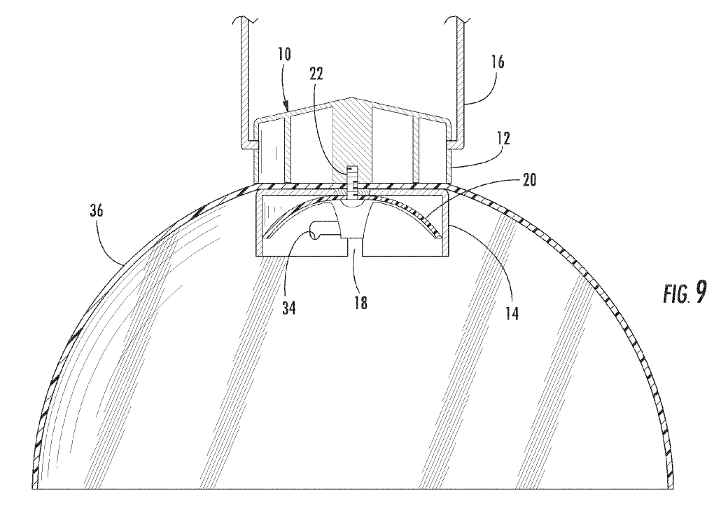

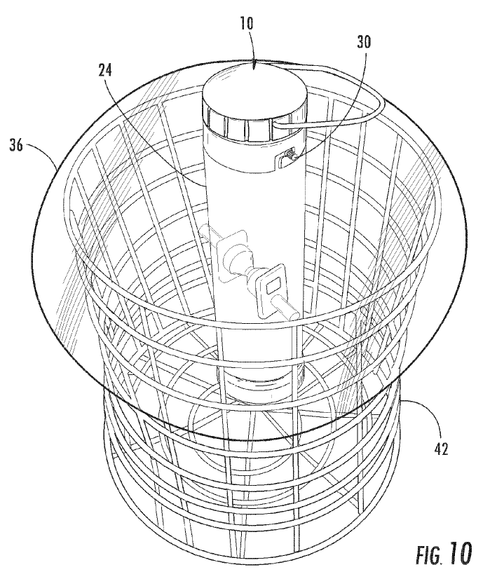

In FIGS. 1 through 7, the upper portion 12 and the lower portion 14 of the top cap 10 can be a unitary unit. However, it may be desirable to incorporate the quick-release features of the top cap 10 in a feeder that includes a large dome-like squirrel guard 36. FIGS. 9-10 show a further use of the invention with a squirrel guard 36. In FIG. 8, the top portion 12 includes a keyed post 38 that engages with a keyed opening 40 in the lower portion 14. As seen in FIGS. 2 and 8, the top portion 12 is secured to the bottom portion 14 with a screw 22. The spring member 20 resides between the head of the screw 22 and the bottom surface of the lower portion 14 of the cap 10. The squirrel guard 36 is embraced between the top portion 12 and the lower portion 14 of the cap 10. The keyed connection of the top portion 12 to the lower portion 14 ensures that rotation of the top portion 12 also rotates the lower portion 14. This is important so that the cap can be rotated by manipulating the top portion 12 that resides above the squirrel guard 36 to make the lower portion 14, which is below the squirrel guard 36, engage with the protrusion 30 on the top of the feeder tube 24.

Thus, as seen in FIG. 9-10, the quick-release top cap 10 of the present invention can be used to accommodate a squirrel guard 36 and position it over a tubular feeder 24. In FIG. 10, the squirrel guard dome 36 can also be used to enclose a cage 42 that surrounds a feeder which is a common desired feeder configuration to protect the feed within the tube 24.

In view of the foregoing, a new and unique quick-release top cap 10 for tubular bird feeders is provided. With this easily removable top cap 10, filling the feeder with feed and cleaning is greatly facilitated thereby improving the overall performance and enjoyment of the tubular bird feeder. The top cap 10 can be used to also carry a squirrel guard 36 without affecting its ability to quickly release and attach to the top of a tubular body 24 of a feeder.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A bird feeder, comprising:
a tubular body member having an open top end and a side wall;
a top cap member interfittingly engaged with the top end of the tubular body member; and
means for releasably securing the top cap member to the tubular body member.

2. The bird feeder of claim 1, wherein the means for releasably securing further comprises:
at least one lock protrusion connected to the tubular body member; and
at least one lock slot on the to cap member that engages the at least one lock protrusion connected to the tubular body member.

3. The bird feeder of claim 2, wherein the at least one lock protrusion connected to the tubular body member is two lock protrusions and the at least one lock slot on the top cap member is two corresponding lock slots on the top cap member.

4. The bird feeder of claim 1, further comprising:
a spring member connected to the top cap, the spring member exerting a biasing force away from the top cap member whereby the open top end of the tubular body member is biased away from the top cap member.

5. The bird feeder of claim 1, further comprising a bail connected to the top cap member.

6. The bird feeder of claim 1, further comprising a squirrel guard attached to the top cap member.

7. The bird feeder of claim 6, further comprising a squirrel cage surrounding the tubular body member and connecting to the squirrel guard.

8. A bird feeder, comprising:
a tubular body member having an open top end and a side wall and at least one lock protrusion connected to the tubular body member;
a top cap member interfittingly engaged with the top end of the body member; and
at least one lock slot on the top cap member that engages the at least one lock protrusion on the tubular body member to releasably secure the top cap member to the tubular body member.

9. The bird feeder of claim 8, wherein the at least one lock protrusion is two lock protrusions on the tubular body member and the at least one lock slot is two corresponding lock slots on the top cap member.

10. The bird feeder of claim 8, further comprising:
a spring member connected to the top cap, the spring member exerting a biasing force away from the top cap member whereby the open top end of the tubular body member is biased away from the top cap member.

11. The bird feeder of claim 8, further comprising a bail connected to the top cap member.

12. The bird feeder of claim 8, further comprising a squirrel guard attached to the top cap member.

13. The bird feeder of claim 12, further comprising a squirrel cage surrounding the tubular body member and connecting to the squirrel guard.

14. A removable top cap for a bird feeder including a tubular body member with an open top end and at least one lock protrusion near the top end, the top cap comprising:
an upper portion;
a lower portion depending from the upper portion, the lower portion interfittingly engaging with the top end of the tubular body member;
at least one lock slot having a lock seat, the at least one lock slot slidably receiving the at least one lock protrusion of the tubular body member into the lock seat to maintain the base and tubular body member releasably secured to one another; and
a spring member connected to the lower portion, the spring member biasing the open top end of the tubular body member away from the lower portion of the top cap.

15. The base of claim 14, wherein the at least one lock slot is two lock slots.

16. The bird feeder of claim 14, further comprising a bail connected to the top cap member.

17. The bird feeder of claim 14, further comprising a squirrel guard attached to the top cap member.

18. The bird feeder of claim 17, further comprising a squirrel cage surrounding the tubular body member and connecting to the squirrel guard.
